(19) United States
(12) Patent Application Publication
(10) Pub. No.: US 2024/0267502 A1
(43) Pub. Date: Aug. 8, 2024

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Kazufumi ONUMA, Kanagawa (JP)

(21) Appl. No.: 18/416,997

(22) Filed: Jan. 19, 2024

(30) Foreign Application Priority Data
Feb. 8, 2023 (JP) 2023-017370

(51) Int. Cl. H04N 13/279; G06T 7/50; G06T 15/04; G10L 25/63

(52) U.S. Cl. CPC H04N 13/279; G06T 7/50; G06T 15/04; G10L 25/63

(57) ABSTRACT

A technique of the present disclosure generates a background video in a virtual viewpoint video with high quality and at low processing cost. Based on three-dimensional shape data indicating the three-dimensional shape of an object generated based on a plurality of images and corresponding to a timecode, an information processing apparatus generates a virtual viewpoint video including a video indicating status information indicating the status of an image capture target of a plurality of image capturing apparatuses and corresponding to the timecode.

### BACKGROUND

### Field

The present disclosure relates to an information processing technique for generating a virtual viewpoint video.

### Description of the Related Art

A virtual viewpoint video generating system can generate an image representing how it looks from a user-specified virtual viewpoint based on images obtained by image capture by an image capturing system using a plurality of image capturing apparatuses, and play it as a virtual viewpoint video.

Japanese Patent Laid-Open No. 2017-211828 discloses, regarding the background of a virtual viewpoint video, generating a background video by using images obtained by as-needed image capture by image capturing apparatuses in an image capturing environment (for example, an electronic signboard, a spectators' stand, and the like in a case of a stadium) as texture of a pre-generated three-dimensional background model. Using images obtained by as-needed image capture by image capturing apparatuses as texture of a pre-generated three-dimensional background model is effective in reproducing how the stadium is, which changes from moment to moment, such as a video displayed on an electronic signboard, a clock, score information, and how excited the spectators are.

Japanese Patent Laid-Open No. 2017-211828 generates texture every time based on images obtained by image capture and therefore faces a problem of tremendous data volume and expensive processing cost. As another problem, because images obtained by image capture by real cameras are used as texture in Japanese Patent Laid-Open No. 2017-211828, for example, a video displayed on an electronic signboard degrades in resolution and changes in color tone from the original video source displayed on the electronic signboard, and the image quality thus lowers.

### SUMMARY

The present disclosure provides an information processing apparatus including:

one or more memories storing instructions; and one or more processors executing the instructions to obtain virtual viewpoint information including information on a position of a virtual viewpoint, information on a direction of a line of sight from the virtual viewpoint, and information on a timecode, obtain three-dimensional shape data indicating a three-dimensional shape of an object generated based on images obtained by a plurality of image capturing apparatuses, the three-dimensional shape data corresponding to the information on the timecode included in the virtual viewpoint information, obtain status information indicating a status of an image capture target of the plurality of image capturing apparatuses, the status information corresponding to the timecode included in the virtual viewpoint information, and based on the three-dimensional shape data, generate a virtual viewpoint video corresponding to the virtual viewpoint information and including a video indicating the status information.

Further features of the present disclosure will become apparent from the following description of exemplary embodiments with reference to the attached drawings.

### BRIEF DESCRIPTION OF THE DRAWINGS

FIG. 1 is a block diagram showing the functional configuration of an information processing system according to the present embodiment;

FIG. 2 is a block diagram showing an example hardware configuration that can be applied to the information processing apparatus according to the present embodiment;

FIG. 3A is an example of how background control information is recorded;

FIG. 3B is an example of how background control information is recorded;

FIG. 3C is an example of how background control information is recorded;

FIG. 3D is an example of how background control information is recorded;

FIG. 4 is a diagram showing the relationship of FIG. 4A and FIG. 4B, and FIG. 4A and FIG. 4B are flowcharts of background video generation in the present embodiment;

FIG. 5A shows an example of how a background video is displayed based on time information;

FIG. 5B shows an example of how a background video is displayed based on time information;

FIG. 6A shows an example of how a background video is displayed based on score information;

FIG. 6B shows an example of how a background video is displayed based on score information;

FIG. 7 shows an example of how a background video is displayed based on video information;

FIG. 8A shows an example of how a background video is displayed based on audience emotion information;

FIG. 8B shows an example of how a background video is displayed based on audience emotion information; and

FIG. 9 shows an example of a graphical user interface for checking background control information.

### DESCRIPTION OF THE EMBODIMENTS

### Embodiment 1

An information processing system of the present embodiment is described. The information processing system of the present embodiment has the function of switching a video to output between a real camera video and a virtual viewpoint video. A real camera video is a video captured by image capturing apparatuses that actually capture images, such as, for example, broadcasting cameras (hereinafter referred to as real cameras), and a virtual viewpoint video is a video corresponding to a virtual viewpoint. A virtual viewpoint is a viewpoint specified by a user. For the convenience of illustration, the following description is given using a camera virtually disposed at the position of a virtual viewpoint (a virtual camera). Thus, the position of a virtual viewpoint and the direction of a line of sight from the virtual viewpoint correspond to the position and the orientation of a virtual camera, respectively. Also, the field of view (the viewing field) from a virtual viewpoint corresponds to the angle of view of the virtual camera.

Also, a virtual viewpoint video in the present embodiment is also called a free viewpoint video, but a virtual viewpoint video is not limited to a video corresponding to a viewpoint specified by a user freely (at will) and includes an image corresponding to a viewpoint selected by a user from a plurality of options. Also, although the present embodiment mainly describes a case where a virtual viewpoint is specified by a user operation, a virtual viewpoint may be automatically specified based on, e.g., image analysis results. Also, the present embodiment mainly describes a case where a virtual viewpoint video is moving images. A virtual viewpoint video can be said as a video captured by a virtual camera.

### (Basic System Configuration and Operation)

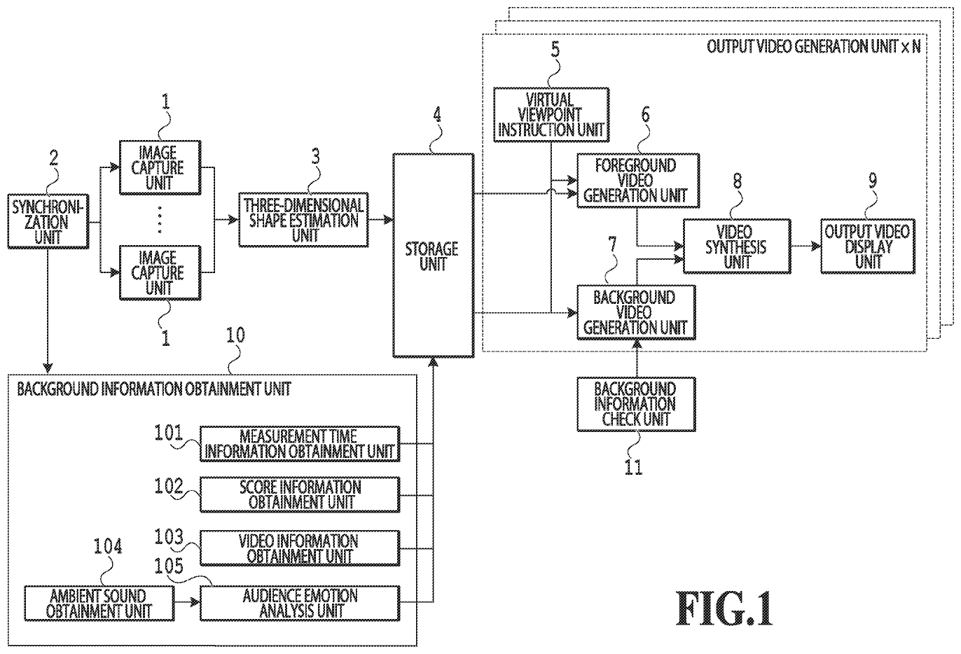

FIG. 1 shows example software configurations of an image capturing system and an information processing apparatus included in an image processing system according to the present embodiment that generates a virtual viewpoint video. The present system is formed by, for example, image capture units 1, a synchronization unit 2, a three-dimensional shape estimation unit 3, a storage unit 4, a virtual viewpoint instruction unit 5, a foreground video generation unit 6, a background video generation unit 7, a video synthesis unit 8, an output video display unit 9, and a background information obtainment unit 10. Note that the present system may be formed by a single electronic device or by a plurality of electronic devices. Also, the following describes the present system on the assumption that a virtual viewpoint video is generated using images obtained by image capture by the plurality of image capture units 1 at a venue where a sporting event is taking place, such as a stadium or an arena.

Next, an overview of the operations of configurations in the information processing apparatus that generates a virtual viewpoint video, to which the present system is applied, is described, and then, detailed descriptions are given of the characteristic configurations of the technique of the present disclosure.

The plurality of image capture units 1 perform image capture in precise synchronization with one another based on a reference time signal indicating a time serving as a reference (hereinafter referred to as a “reference time”) and a synchronization signal serving as a reference (hereinafter referred to as a “reference synchronization signal”) outputted from the synchronization unit 2. Then, the image capture units 1 each assign a frame number generated based on the reference time signal and the reference synchronization signal to a captured image obtained by image capture and outputs the captured image including the frame number to the three-dimensional shape estimation unit 3. Note that the image capture units 1 may be placed in such a way as to surround an object so as to be able to capture images of the object from a plurality of directions.

Using inputted captured images from a plurality of viewpoints, the three-dimensional shape estimation unit 3 generates three-dimensional shape data on an object by, for example, extracting a silhouette of the object and using visual hull or the like. The three-dimensional shape estimation unit 3 also outputs the generated three-dimensional shape data on the object and the captured images of the object to the storage unit 4. In the present embodiment, the three-dimensional shape estimation unit 3 has not only a three-dimensional shape data generation function but also a captured-image obtainment function. Note that an object as mentioned here includes a person and an article handled by a person, which are targeted for generation of three-dimensional shape data.

The storage unit 4 is used to save and accumulate the following group of data as virtual viewpoint video materials. Specifically, the group of data includes captured images and three-dimensional shape data on an object inputted from the three-dimensional shape estimation unit 3, camera parameters of the plurality of image capture units 1, such as their positions (positions in a three-dimensional space), orientations (pan, tilt, and roll), and optical characteristics, and the like.

The virtual viewpoint instruction unit 5 is formed by a virtual viewpoint operation unit as a physical user interface, such as a joystick or a jog dial (not shown), and a display unit for displaying a virtual viewpoint video representing how it looks from the virtual viewpoint being operated. The virtual viewpoint instruction unit 5 generates virtual viewpoint information based on an input from the virtual viewpoint operation unit and inputs the virtual viewpoint information to the foreground video generation unit 6 and the background video generation unit 7. The virtual viewpoint information includes information corresponding to extrinsic parameters of the virtual cameras such as the position of a virtual viewpoint position (a position in a three-dimensional space) and the orientation (pan, tilt, and roll), information corresponding to intrinsic parameters of the virtual cameras such as the focal length and the angle of view, and time information specifying a time of image capture. Note that in the present embodiment, the time information specifying a time of image capture is a timecode expressed by a frame number or the like.

Based on the time information included in the virtual viewpoint information inputted, the foreground video generation unit 6 obtains, from the storage unit 4, data corresponding to the time of image capture. Based on, among the data obtained, three-dimensional shape data on a foreground object and captured images of the foreground object, the foreground video generation unit 6 generates a foreground video representing how the foreground object looks from the virtual viewpoint specified in the inputted virtual viewpoint information, and outputs the foreground video to the video synthesis unit 8. In the foreground video outputted by the foreground video generation unit 6, a portion other than the foreground object is transparent.

The background video generation unit 7 generates a video representing how a background 3DCG model, which is three-dimensional shape data with texture generated in advance, looks from the virtual viewpoint specified in the inputted virtual viewpoint information, and outputs the generated video to the video synthesis unit 8 as a background video. Note that the background 3DCG model may be generated using three-dimensional shape data on a background generated by the three-dimensional shape estimation unit 3 based on captured images not including a foreground object or partial images of captured images not including a foreground object. Note that 3DCG is an abbreviation for three-dimensional computer graphics.

The video synthesis unit 8 synthesizes a foreground video and a background video inputted thereto. Because a background portion of the foreground video is transparent, the video synthesis unit 8 utilizes this for synthesis and outputs the synthesized video to the output video display unit 9. Also, the following synthesis processing may be performed. Specifically, distance information indicating the distances from the virtual viewpoint to objects may be added to the foreground video and the background video, and rendering of the objects are performed from the ones that are closer to the virtual viewpoint to reproduce occlusion.

The output video display unit 9 displays a virtual viewpoint video inputted from the video synthesis unit 8.

Also, in a case where the virtual viewpoint instruction unit 5, the foreground video generation unit 6, the background video generation unit 7, the video synthesis unit 8, and the output video display unit 9 are grouped together to form an output video generation unit, the image processing system may include a plurality of (N) output video generation units.

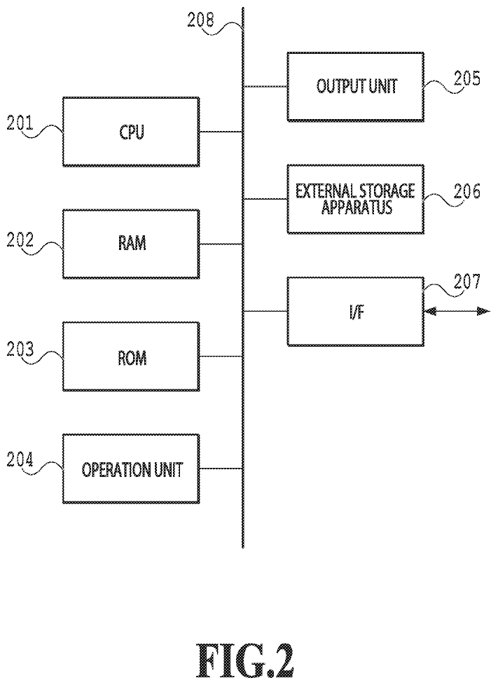

FIG. 2 is a block diagram showing an example hardware configuration of the information processing apparatus that generates a virtual viewpoint video according to the present embodiment.

A CPU 201 performs overall control of the information processing apparatus using computer programs and data stored in a RAM 202 and a ROM 203 and also functions as the processing units shown in FIG. 1, except for the image capture units 1.

The RAM 202 has an area for temporarily storing computer programs and data loaded from an external storage apparatus 206, data obtained from outside via an interface (I/F) 207, and the like. The RAM 202 further has a work area used by the CPU 201 in executing various kinds of processing. In other words, for example, the RAM 202 can be allocated as frame memory and provide other various areas as needed.

The ROM 203 stores settings data, a boot program, and the like for the computer. An operation unit 204 is formed by a keyboard, a mouse, and/or the like, and allows various instructions to be inputted to the CPU 201 by being operated by a user of the information processing apparatus. An output unit 205 displays results of processing by the CPU 201. Also, the output unit 205 is formed by, for example, a liquid crystal display. For example, a viewpoint operation unit can be formed by the operation unit 204, and the output video display unit 9 can be formed by the output unit 205.

The external storage apparatus 206 is a large-capacity information storage apparatus, typified by a hard disk drive apparatus. The external storage apparatus 206 is used to save an operating system (OS) and computer programs for causing the CPU 201 to implement the functions of the units shown in FIG. 1. Further, image data to be processed may be saved in the external storage apparatus 206.

Computer programs and data saved in the external storage apparatus 206 are loaded into the RAM 202 as controlled by the CPU 201 as needed and processed by the CPU 201. A network such as a LAN and the Internet and other devices such as a projection apparatus or a display apparatus can be connected to the I/F 207, and the present information processing apparatus can obtain and send various kinds of information via this I/F 207. In the present disclosure, the image capture units 1 are connected to the I/F 207, so that captured images from the image capture units 1 can be inputted, and the image capture units 1 can be controlled. A bus 208 is a data transmission path connecting the units described above.

### (Characteristic Configurations and Operations of the Technique of the Present Disclosure)

Next, the characteristic components of the technique of the present disclosure and their specific operations are described using the configuration diagram shown in FIG. 1. Of these components, a description is given of details of the background information obtainment unit 10 that obtains, e.g., information indicating the status of a target of image capture by the image capture unit 1, which is a characteristic component of the technique of the present disclosure.

The background information obtainment unit 10 is formed by several different obtainment units for the respective kinds of background control information and material data to obtain. In the present embodiment, the background information obtainment unit 10 is formed by a measurement time information obtainment unit 101, a score information obtainment unit 102, a video information obtainment unit 103, an ambient sound obtainment unit 104, and an audience emotion analysis unit 105. The following describes how these obtainment and analysis units obtain and record background control information and material data.

The obtainment and analysis units forming the background information obtainment unit 10 are all connected to the synchronization unit 2 and have time information in synchronization with the time of image capture of captured images used as materials of a virtual viewpoint video. The obtainment units obtain various kinds of background control information and material data to be described later and store the background control information and material data in the storage unit 4 along with time information indicating the time of obtainment of them.

Specific methods for obtaining background control information and material data are described here.

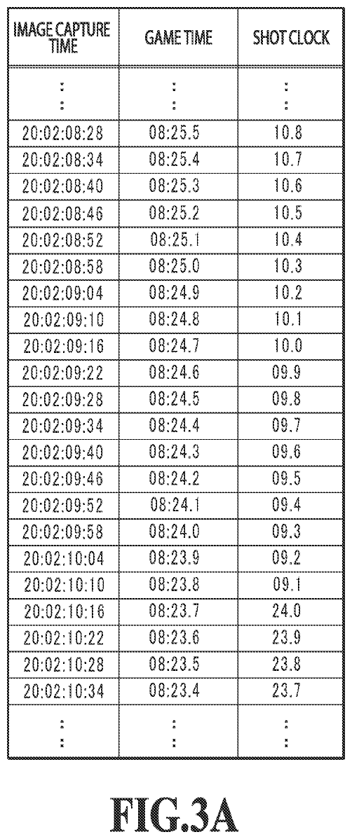

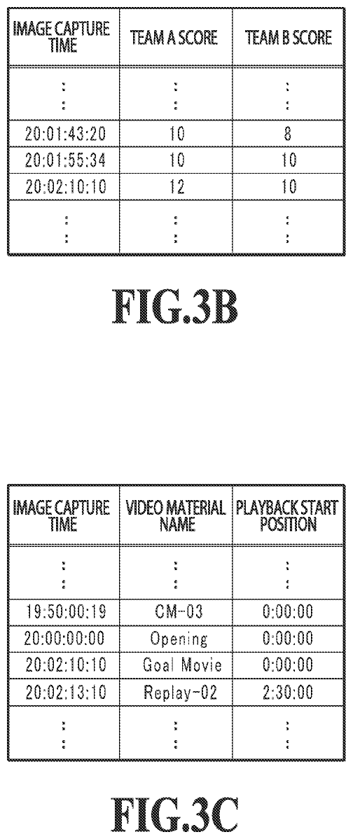

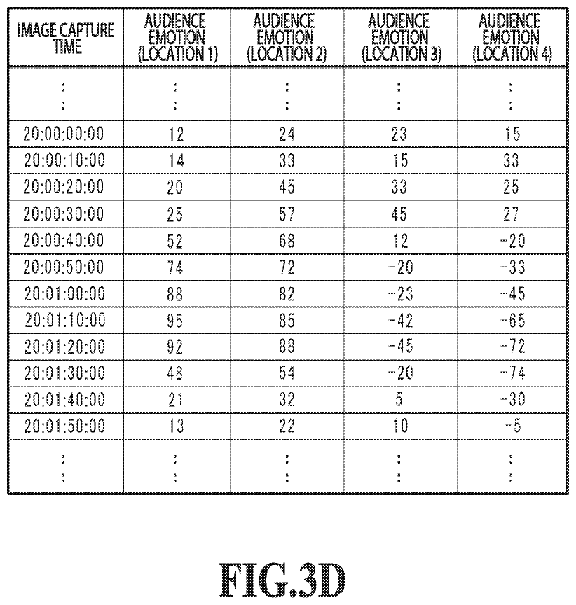

The measurement time information obtainment unit 101 obtains information related to time counted during a game which is predetermined for every sporting event (hereinafter referred to as “measurement time information”) and sequentially stores the measurement time information in the storage unit 4 while linking it with an image capture time. This measurement time information may include a plurality of pieces of time information. For instance, in a case of basketball, the following two times are counted simultaneously and independently: a time indicating how much time is left in a quarter and a shot clock indicating how much time a team possessing a ball has before they have to shoot the ball. Thus, these measurement times are obtained individually and stored in the storage unit 4 while being linked with the image capture time. The measurement time information is counted in 10 milliseconds and stored while being linked with an image capture time outputted from the synchronization unit 2. Specifically, for example, in a case of an image capturing system with a frame rate of 59.94 fps, as shown in FIG. 3A, an image capture time and a time, such as a game time and a shot clock, are recorded in every 6 frames while being linked with each other. The obtainment of these pieces of measurement time information is achieved by obtaining various kinds of measurement time information managed by a body governing the sporting event. Also, the measurement time information may be obtained from a captured video. Also, in a case where a concert is an image capture target, the measurement time information may be, for example, a time measured from the start of a song sung by a singer. Also, in a case where a run is an image capture target, the measurement time information may be a lap time for a 5000-meter run or the like.

The score information obtainment unit 102 obtains game score information. Specifically, the score information obtainment unit 102 obtains information related to a scoreboard and operation of the scoreboard from a scoreboard system managed by a body governing the sporting event. Because score information is not continuous information, as shown in FIG. 3B, score information is stored in the storage unit 4 while being linked with the image capture time, only at the timing of a change in the scores. Score information may be obtained from various apparatuses managed by the body governing the sporting event or may be obtained by capturing an image of, e.g., a display at the game venue displaying the scores. Also, the score information may be, for example, a record set by each player in a sporting event. Specifically, the score information may be a 100-meter-run record, a hammer-throw record, a high-jump record, or the like. The score information may also be scores or records for other sporting events.

The video information obtainment unit 103 obtains information related to a video related to display of an electronic signboard and an electronic billboard placed at a game venue. Specifically, the information is video control information related to material data (a video material) for a video displayed on various kinds of display apparatuses and to the playback start time thereof. For instance, in a case of an advertisement video on an electronic billboard, the advertisement video is obtained as a video material from an input unit (not shown) and stored in the storage unit 4 in advance, and identification information on the video material thus obtained and information indicating a playback position of the video material are stored in the storage unit 4 while being linked with an image capture time. Also, in a case where a video of the game captured by a real camera is being displayed on an electronic signboard, the video captured by the real camera is obtained as a video material, and the video material is stored in the storage unit 4 while being linked with an image capture time at which the video material was displayed. Specifically, as shown in FIG. 3C, a video material name for identifying the video material and video control information indicating the playback start position of the video material are linked with the image capture time and stored. In a case where the video material is stopped halfway, the playback stop position is also included in the video control information.

A plurality of ambient sound obtainment units 104 are placed to collect sound around the spectators' seats. The ambient sound obtainment units 104 collect sound based on which a response from the audience can be estimated, such as cheers and applauds from the audience and the sound of noisemakers, and outputs the audio thus collected to the audience emotion analysis unit 105. The audience emotion analysis unit 105 analyzes the audio inputted from the ambient sound obtainment unit 104 to determine whether, e.g., the emotion of the audience is positive or negative and stores the analysis result thus derived in the storage unit 4 as audience emotion information while being linked with the image capture time of the sound collection. In this analysis, the audience emotion analysis unit 105 analyzes the emotion of the audience based on, for example, the pitch (high or low) of the audio and words uttered by the audience. Additionally, the audio materials obtained by the ambient sound obtainment units 104 are also stored. In a sport where the spectators' seats for supporters to sit are predetermined for the respective teams, such as baseball and soccer, several ambient sound obtainment units 104 are placed for each team's spectators' seats. Then, for example, the audience emotion analysis unit 105 analyzes audience emotion based on audio obtained by each ambient sound obtainment units 104 and stores the individual audience emotion in the storage unit 4 in every, for example, one second while linking them with the image capture time of the sound collection. Note that the audience emotion is expressed in a numerical value from −100 to 100 as shown specifically in FIG. 3D, and the positivity and negativity of the emotion is indicated by the plus or negative sign of the value. Although recorded in every ten seconds in the present embodiment for the convenience of the illustration, the audience emotion information can be recorded at any time intervals.

The background control information and material data obtained by the above obtainment and analysis units are stored in the storage unit 4 while being linked with the image capture time and are used to generate a background video in a virtual viewpoint video. Note that for each piece of background control information, which CG object in a background 3DCG model is controlled by the background control information is set in the background video generation unit 7 in advance.

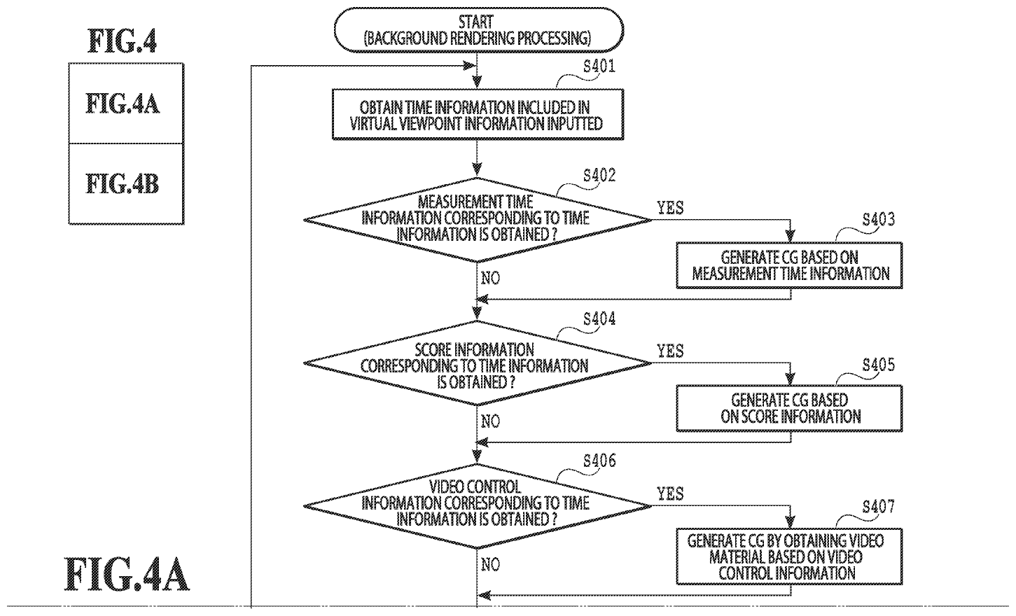

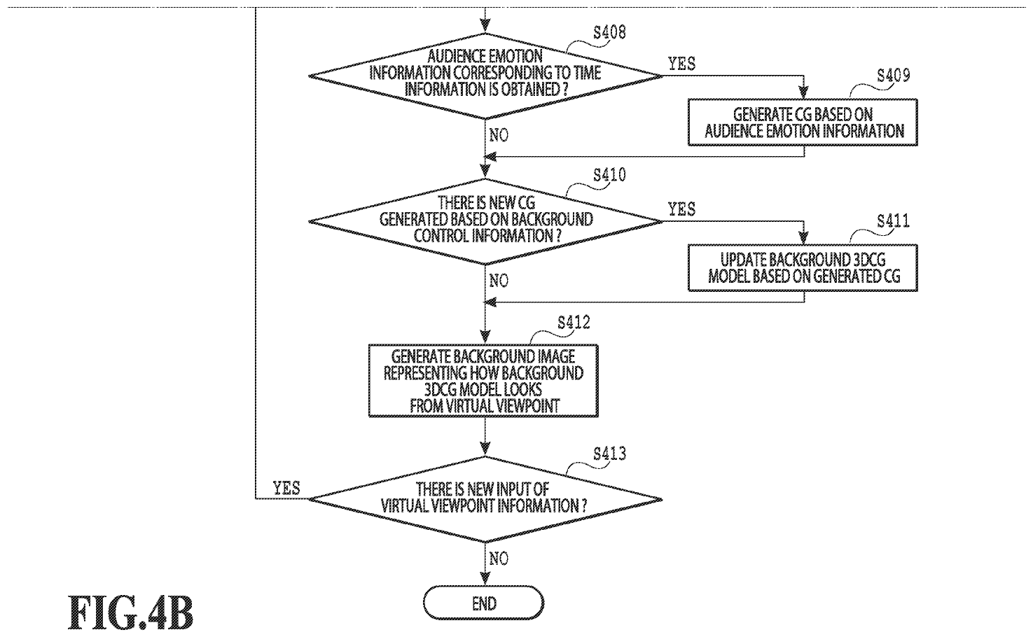

FIG. 4A and FIG. 4B show flowcharts illustrating a characteristic part of the technique of the present disclosure, namely, steps of referring to the background control information recorded in the storage unit 4 and using them to generate a background video.

In S401, the background video generation unit 7 obtains time information included in virtual viewpoint information inputted from the virtual viewpoint instruction unit 5.

In S402, the background video generation unit 7 determines whether measurement time information linked with an image capture time specified in the obtained time information can be obtained from among pieces of measurement time information obtained by the measurement time information obtainment unit 101 and stored in the storage unit 4 as background control information. If corresponding measurement time information exists and can be obtained, the processing proceeds to S403, and if corresponding measurement time information does not exit and cannot be obtained, the processing proceeds to S404.

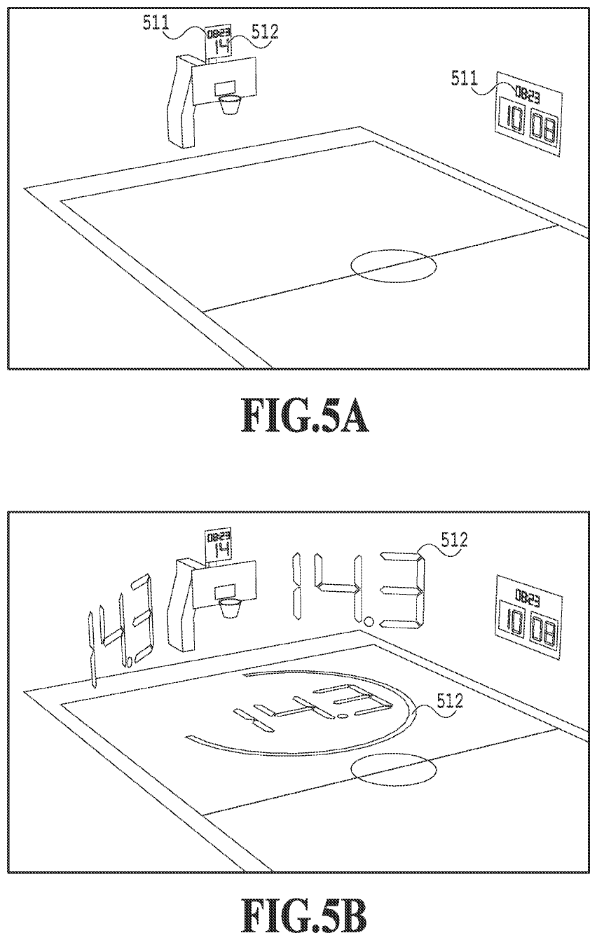

In S403, the background video generation unit 7 generates CG based on the obtained measurement time information, which can be applied to the background 3DCG model. Here, measurement time information for a basketball game is used as an example. Because two pieces of measurement time information are recorded as measurement time information in basketball, namely a game time in each quarter and a shot clock count, they are both obtained as measurement time information. Then, texture images of a game time 511 and a shot clock 512 are generated based on the measurement time information and are mapped to the background 3DCG model like the one shown in, for example, FIG. 5A. The texture images may be mapped at locations similar to the usual locations as shown in FIG. 5A, or they may be mapped on the court surface or up in the air like, for example, the shot clock 512 shown in FIG. 5B. For example, a virtual object not existing in an actual space and not captured by a real camera may be placed in a virtual space, and a texture image may be used as its texture. Because such a representation is also rendered not based on a video captured by a real camera but in CG based on the background control information, a high-resolution image with high affinity to the background 3DCG model can be achieved.

In S404, the background video generation unit 7 determines whether score information linked with the image capture time specified in the obtained time information can be obtained from among pieces of score information obtained by the score information obtainment unit 102 and stored in the storage unit 4 as background control information. Because the score information is recorded only at the timing of a change, in a case where the image capture time corresponding to the background image to generate is 20:01:52:33 with the records being as shown in FIG. 3B, the background video generation unit 7 searches for and obtains score information recorded in the immediate past. In this case, score information linked with the time of image capture 20:01:43:20 is obtained. If corresponding score information exits and can be obtained, the processing proceeds to S405, and if corresponding score information does not exit and cannot be obtained, the processing proceeds to S406.

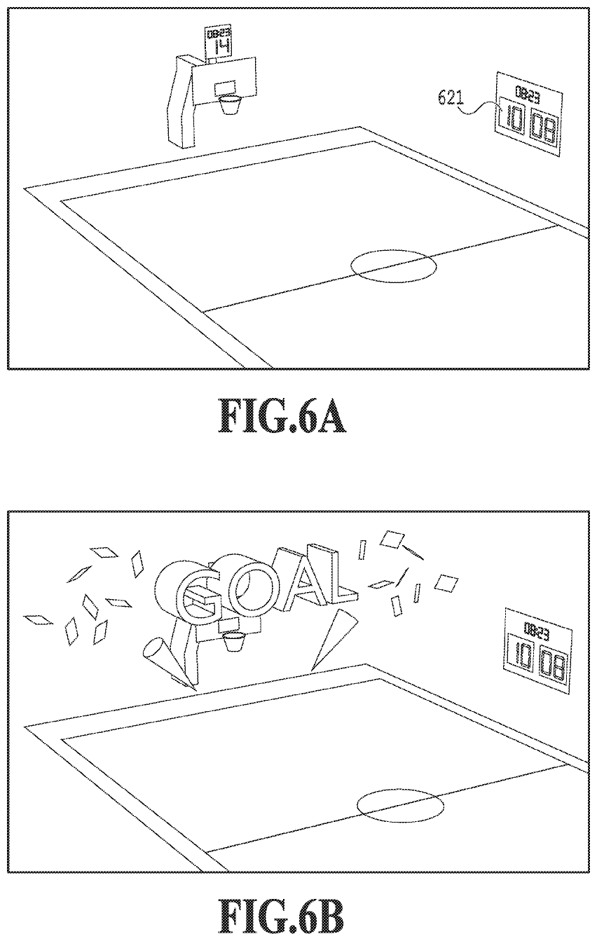

In S405, the background video generation unit 7 generates CG based on the obtained score information, which can be applied to the background 3DCG model. For example, as shown in FIG. 6A, the background video generation unit 7 generates a texture image representing a scoreboard score display 621 for the background 3DCG model. Also, the background video generation unit 7 may detect timing of update of score information and render CG expressing that a point has been scored on the background 3DCG model, as shown in FIG. 6B. For example, such CG may be rendered using a virtual object placed in a virtual space.

In S406, the background video generation unit 7 determines whether video control information linked with the image capture time specified in the obtained time information can be obtained from among pieces of video control information obtained by the video information obtainment unit 103 and stored in the storage unit 4 as background control information. If corresponding video control information exits and can be obtained, the processing proceeds to S407, and if corresponding video control information does not exit and cannot be obtained, the processing proceeds to S408.

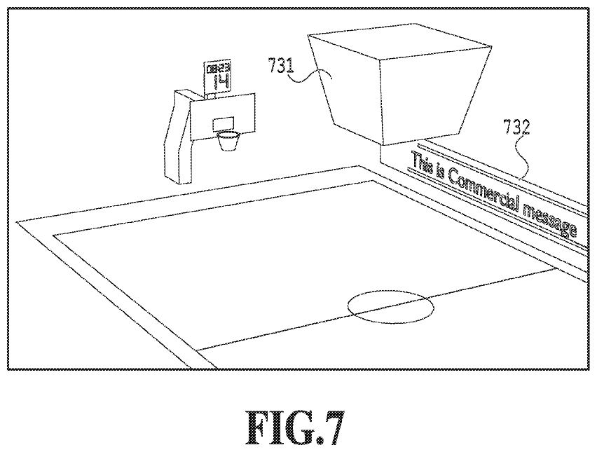

In S407, based on the obtained video control information, the background video generation unit 7 generates CG that can be applied to the background 3DCG model. Specifically, the background video generation unit 7 obtains a corresponding video material from the storage unit 4 based on the video control information, identifies the playback position of the video material, and generates CG having embedded therein a video played back from the identified playback position of the video material obtained. Note that the playback position of the video material can be identified by finding the difference between the image capture time at which playback of the video material is started and the image capture time specified in the time information obtained in S401. The video obtained by playback of the video material can be mapped at any position on the background 3DCG model, such as, for example, an electronic signboard 731 or an electronic billboard 732 as shown in FIG. 7.

In S408, the background video generation unit 7 determines whether audience emotion information linked with the image capture time specified in the obtained time information can be obtained from among pieces of audience emotion information generated by the audience emotion analysis unit 105 and stored in the storage unit 4 as background control information. If corresponding audience emotion information exists and can be obtained, the processing proceeds to S409, and if corresponding audience emotion information does not exist and cannot be obtained, the processing proceeds to S410.

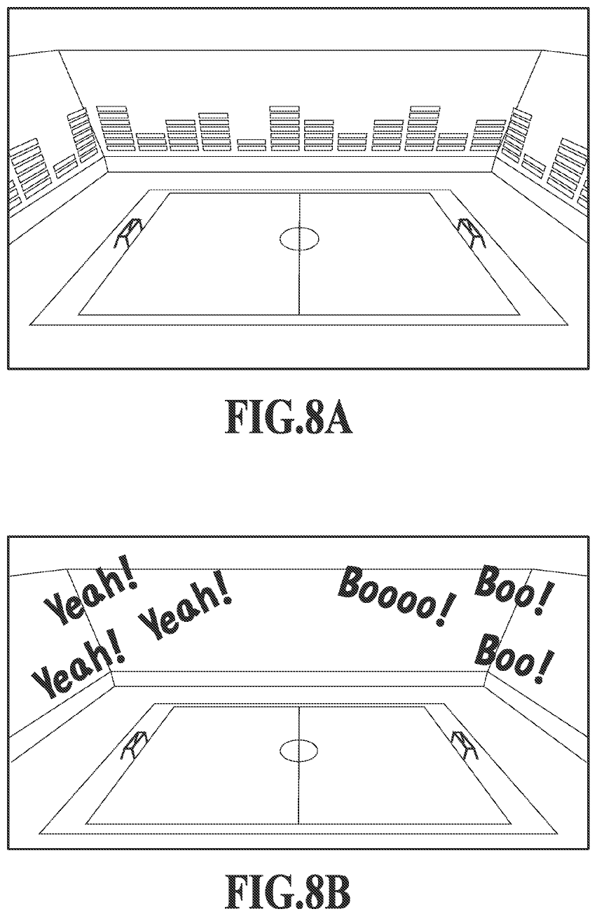

In S409, based on the audience emotion information obtained, the background video generation unit 7 generates CG that can be applied to the background 3DCG model. As the CG based on the audience emotion information, for example, level bars may be displayed at the spectators' seats as shown in FIG. 8A, changing depending on results of spectrum analysis performed on audio data and thereby visualizing how excited people are at the venue. Also, the effect as shown in FIG. 8A may be displayed once the audience emotion information obtained exceeds a certain threshold. In a case where the audience emotion information is a threshold or above, the audience emotion may be determined as positive, and “Yeah!” may be displayed. In a case where the audience emotion information is below a threshold, the audience emotion may be determined negative, and “Boo!” may be displayed. The threshold is, for example, 30 in absolute value.

In S410, the background video generation unit 7 determines whether there is any CG generated based on background control information in S403, S405, S407, or S409. If there is any CG generated based on background control information, the processing proceeds to S411, and if there is no CG generated based on background control information, the processing proceeds to S412.

In S411, the background video generation unit 7 incorporates the CG generated based on the background control information in S403, S405, S407, or S409 into the background 3DCG model and thereby updates the background 3DCG.

In S412, following the virtual viewpoint information inputted and using the background 3DCG model, the background video generation unit 7 generates a background image representing how the background 3DCG model looks from the specified virtual viewpoint. Note that in a case where there is an already-generated background image with the same position and orientation of the virtual viewpoint in the virtual viewpoint information and the same background 3DCG model, the background image generated in S412 may be a copy of the already-generated background image, with the time information obtained in S401 added thereto.

In S413, the background video generation unit 7 determines whether there is a new input of virtual viewpoint information. If there is a new input of virtual viewpoint information, the processing proceeds back to S401, and if there is no new input of virtual viewpoint information, the background rendering processing ends.

In this way, the background video generation unit 7 repeats this processing from S401 to S413 on virtual viewpoint information inputted from the virtual viewpoint instruction unit 5 for every frame and generates a background image based on the background 3DCG model changing based on the background control information. Also, because the background 3DCG is updated using CG generated based on background control information, data volume and processing load are small compared to a case where the background 3DCG are generated based on captured images.

Note that the background 3DCG model updated based on measurement time information, score information, and the like continues to be used after that. Meanwhile, CG representing that a point has been scored as shown in FIG. 6B, an advertisement video as shown in FIG. 7, CG representing how excited the audience is as shown in FIG. 8B, and the like are removed from the background 3DCG model after being displayed for a set length of time. How to update the background 3DCG model may be set and controlled by the background video generation unit 7 for each CG object or may be set in background control information so that the background video generation unit 7 can control the update based on the background control information.

Also, in a case where virtual viewpoint information inputted indicates the same position and orientation of a virtual viewpoint as virtual viewpoint information on an already-generated background image, the background video generation unit 7 may directly update the background video generated before, based on the background control information. This eliminates processing for updating the background 3DCG model and rendering the updated background 3DCG model.

As described earlier, the video synthesis unit 8 generates an output video by synthesizing the background video generated by the background video generation unit 7 and the foreground video generated by the foreground video generation unit 6.

According to the present embodiment, presentations such as times, scores, and advertisements displayed in a virtual stadium can be displayed in a virtual viewpoint video at the timing at which they are displayed in the actual stadium, without using captured images obtained by as-needed image capture as texture of the three-dimensional background model. Also, changes in how excited the audience is and the like can be represented in CG based on audio data which is lighter than captured images. Thus, the present embodiment can provide a video experience where a user can feel the atmosphere of the actual stadium, with the background being virtual and requires low processing load.

Also, compared to an approach of generating texture data by capturing images of an actual stadium like with a conventional approach, data to be stored and processed is not image data but numerical information. This drastically reduces the volume of data to be stored and processed. Also, video representations that are impossible to implement in an actual space, like the ones shown in the present embodiment, can be implemented.

Also, with recent development in virtual reality and metaverse, a video may be generated such that a sporting event taking place in a stadium is combined not with the actual stadium but with a 3DCG stadium. In a case where such a CG stadium is used, using CG representations like in the present embodiment to display score information and time information provides higher affinity in image quality and more suitable as a video than using captured videos.

### (Other Modes of the Present Embodiment)

Although the measurement time information obtainment unit 101 and the score information obtainment unit 102 are configured to obtain information from a governing body in the present embodiment describe above, the present disclosure is not necessarily limited to this. For example, the following configuration may be employed. In a case where score information cannot be obtained directly, images of electronic signboards or the like displaying measurement times and scores are captured with image capture units, image analysis is performed thereon to obtain measurement time information and store information, and they may be recorded in the storage unit 4 as background control information.

In the present embodiment, background control information may include, for example, information related to the weather and sunshine or player information on the players in the game, and they may be used to dynamically change the weather and sunshine of the background 3DCG model or display the player information on a virtual electronic signboard.

Also, although the background information obtainment unit 10 described in the present embodiment is configured including the measurement time information obtainment unit 101, the score information obtainment unit 102, the video information obtainment unit 103, the ambient sound obtainment unit 104, and the audience emotion analysis unit 105, the present disclosure is not necessarily limited to this. The background information obtainment unit 10 may be configured to use only some of these obtainment units or may additionally have a configuration for obtaining and recording other information as background control information. Also, although not related to an actual background object, a comment posted on a social networking service as a real-time response to an image capture target may be recorded and included in background control information. In this case, the comment may be displayed, or whether the comment is a positive or negative opinion may be determined, and an effect representation may be presented based on the nature of the opinion.

Also, the processing shown in the flowchart in FIG. 4A and FIG. 4B of the present embodiment and in the present embodiment, namely S402 to S408, does not necessarily have to be performed in this order, and the order may be changed. Also, processing in S402 to S408 may be performed in parallel.

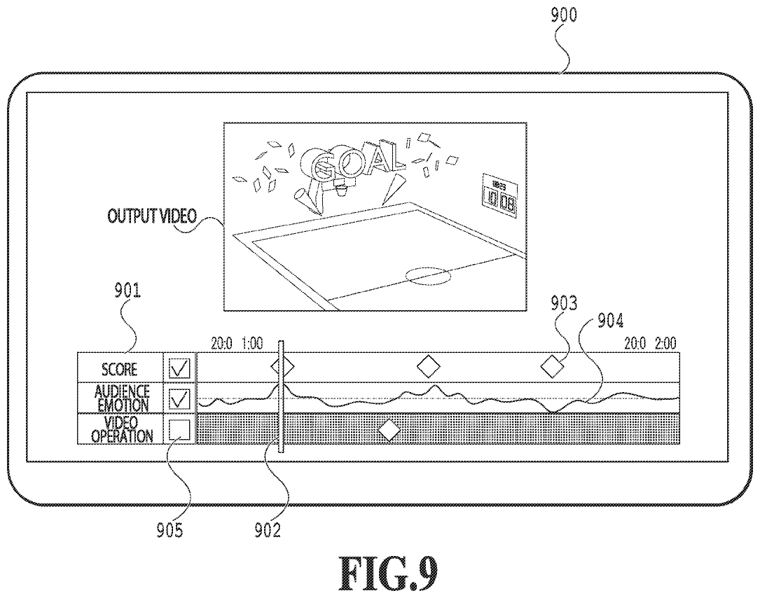

Although no particular description has been given in the present embodiment for the configuration for displaying the background control information itself, the background control information may be displayed on a background information check unit 11 connected to the background video generation unit 7. Note that the background control information is displayed on the background information check unit 11 not as tables shown in FIGS. 3A to 3D but using a graphical user interface (GUI) like, for example, the one shown in FIG. 9. The GUI shown in FIG. 9 has a timeline 901 for score information, audience emotion information, and video control information and a bar 902 indicating the current playback time (frame number). A key frame icon 903 may be displayed on the timeline 901 to indicate a frame of the time of background control information recorded and linked. Also, a graph 904 may be displayed for background control information for which a numerical parameter is recorded, such as audience emotion information. Also, for video control information, a corresponding frame extracted from a video material may be displayed on the timeline 901 as a thumbnail image.

Also, it may be configured to be able to select whether to apply CG based on background control information to the background 3DCG model during playback by, e.g., providing a checkbox 905 on the timeline 901 for each type of background control information and generating a video going back in time for generation of a highlight scene.

Also, it may be designed such that the key frame icon 903 for the video control information can be sought so that the video operating timing can be corrected afterwards. Also, the GUI may additionally have the function of switching validity for each key frame and the function of deleting the key frame so that the background control information can be edited on the background information check unit 11.

Although a background portion in a foreground video is transparent in the present embodiment described above, the present disclosure is not necessarily limited to this. For example, a background portion in a foreground video may be in a single color, for example green, and the video synthesis unit 8 performs synthesis using chroma key compositing.

In the present embodiment, for the sake of simplicity, the foreground video generation unit 6 that generates a foreground video and the background video generation unit 7 that generates a background video are expressed as different components, and the video synthesis unit 8 synthesizes these videos. However, the present disclosure is not limited to this configuration. The foreground video generation unit 6 and the background video generation unit 7 may be implemented as a single video generation unit. Specifically, three-dimensional shape data on a foreground object and a background 3DCG model may be combined to generate a virtual viewpoint video by rendering the foreground object using captured images as texture. In this case, the video synthesis unit 8 is unnecessary.

Although a virtual viewpoint video is outputted to the output video display unit 9 in the present embodiment, the output destination does not necessarily have to be a display device, and a virtual viewpoint video may be outputted to, for example, a video recording apparatus or a video distribution apparatus.

Although each background video generation unit 7 holds a pre-generated background 3DCG model in the present embodiment described above, the present disclosure is not necessarily limited to this. For example, a background 3DCG model may be stored in the storage unit 4, and each background video generation unit 7 may obtain the background 3DCG model from the storage unit 4 upon activation and use it.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

The present disclosure can generate a background video in a virtual viewpoint video with high quality with low processing cost.

This application claims the benefit of Japanese Patent Application No. 2023-017370 filed Feb. 8, 2023, which is hereby incorporated by reference wherein in its entirety.

What is claimed is:

1. An information processing apparatus comprising:
one or more memories storing instructions; and
one or more processors executing the instructions to
obtain virtual viewpoint information including information on a position of a virtual viewpoint, information on a direction of a line of sight from the virtual viewpoint, and information on a timecode,
obtain three-dimensional shape data indicating a three-dimensional shape of an object generated based on images obtained by a plurality of image capturing apparatuses, the three-dimensional shape data corresponding to the information on the timecode included in the virtual viewpoint information,
obtain status information indicating a status of an image capture target of the plurality of image capturing apparatuses, the status information corresponding to the timecode included in the virtual viewpoint information, and
based on the three-dimensional shape data, generate a virtual viewpoint video corresponding to the virtual viewpoint information and including a video indicating the status information.

2. The information processing apparatus according to claim 1, wherein
the status information includes measurement time information related to time measured for the image capture target.

3. The information processing apparatus according to claim 1, wherein
the status information includes information related to a score or a record in a game which is the image capture target.

4. The information processing apparatus according to claim 1, wherein
the status information includes video control information related to identification information on a video material displayed at a venue of the image capture target and a playback start position of the video material.

5. The information processing apparatus according to claim 1, wherein
the status information includes player information on a player in a game which is the image capture target.

6. The information processing apparatus according to claim 1, wherein
the status information includes information related to audience's response to a game which is the image capture target.

7. The information processing apparatus according to claim 6, wherein
the information related to the audience's response is information indicating audience emotion derived based on audio from the audience of the game which is the image capture target.

8. The information processing apparatus according to claim 6, wherein
the information related to the audience's response includes a comment posted on a social networking service about the game which is the image capture target.

9. The information processing apparatus according to claim 1, wherein
the status information includes information related to weather and sunshine.

10. The information processing apparatus according to claim 1, wherein
texture of a background model is updated based on the status information, and
the virtual viewpoint video is generated based on the updated background model.

11. The information processing apparatus according to claim 1, wherein
a model of a virtual object is generated based on the status information, and
the virtual viewpoint video is generated based on the model of the virtual object thus generated.

12. The information processing apparatus according to claim 1, wherein
the status information is edited based on a user input.

13. An information processing method for performing processing for generating a virtual viewpoint video using a plurality of images obtained by synchronized image capture by a plurality of image capturing apparatuses, the information processing method comprising:
obtaining virtual viewpoint information including information on a position of a virtual viewpoint, information on a direction of a line of sight from the virtual viewpoint, and information on a timecode,
obtaining three-dimensional shape data indicating a three-dimensional shape of an object generated based on the plurality of images, the three-dimensional shape data corresponding to the information on the timecode included in the virtual viewpoint information,
obtaining status information indicating a status of an image capture target by the plurality of image capturing apparatuses, the status information corresponding to the timecode included in the virtual viewpoint information, and
based on the three-dimensional shape data, generating a virtual viewpoint video corresponding to the virtual viewpoint information and including a video indicating the status information.

14. A non-transitory computer readable storage medium storing a program which causes a computer to execute an information processing method for performing processing for generating a virtual viewpoint video using a plurality of images obtained by synchronized image capture by a plurality of image capturing apparatuses, the information processing method comprising:
obtaining virtual viewpoint information including information on a position of a virtual viewpoint, information on a direction of a line of sight from the virtual viewpoint, and information on a timecode,
obtaining three-dimensional shape data indicating a three-dimensional shape of an object generated based on the plurality of images, the three-dimensional shape data corresponding to the information on the timecode included in the virtual viewpoint information,
obtaining status information indicating a status of an image capture target by the plurality of image capturing apparatuses, the status information corresponding to the timecode included in the virtual viewpoint information, and
based on the three-dimensional shape data, generating a virtual viewpoint video corresponding to the virtual viewpoint information and including a video indicating the status information.
